(19) United States
(12) Patent Application Publication
(10) Pub. No.: US 2010/0314376 A1
(43) Pub. Date: Dec. 16, 2010

(54) ROBOT HOLDER FOR FLUID-COOLED JOINING TOOLS

(75) Inventors: Peter Zander, Norderstedt (DE); Christopher Mewes, Kaltenkirchen (DE); Dirk Dzelnitzki, Hamburg (DE)

Correspondence Address: SAND & SEBOLT, AEGIS TOWER, SUITE 1100, 4940 MUNSON STREET, NW, CANTON, OH, 44718-3615, US

(73) Assignee: DINSE GMBH, Hamburg (DE)

(21) Appl. No.: 12/743,061

(22) PCT Filed: Oct. 10, 2008
(86) PCT No.: PCT/EP2008/063689

§ 371 Date: Aug. 2, 2010

(30) Foreign Application Priority Data
Nov. 16, 2007 (DE) 202007016161.1

(51) Int. Cl. B23K 9/28

(52) U.S. Cl. 219/138

(57) ABSTRACT

The invention relates to a robot holder for fixing a fluid-cooled joining tool (6) rotatably about a longitudinal axis (L) on a robot arm (2) of a joining robot with a stator (3) that can be fixed on the robot arm (2) and a rotor (4), which comprises a connection for the joining tool (6) and can be rotated about the stator (3), wherein a feed-through (13) for a joining medium, particularly a welding or soldering wire, runs inside the robot holder through the stator and the rotor. For the even more flexible use of such automated joining tools operating with a joining medium on robots, it is desirable to enable for a rotation of the joining tool that is less limited in the angular range, preferably by a range of at least 360° and even more up to rotatability that is delimited by robot parameters but otherwise free, and to create an accordingly adapted passage for cooling fluid. According to the invention, the robot holder comprises in the stator (3) and in the rotor (4) at least one fluid line designed as bore (8a, 8b, 9a, 9b) for a cooling fluid feed and the cooling fluid return, wherein between the stator (3) and the rotor (4) at least one sealed annular chamber (10, 11) is formed for the cooling fluid feed and the cooling fluid return, the respectively associated fluid lines of the stator (3) and the rotor (4) for a fluid passage ending in said annular chamber. The invention further relates to a joining robot comprising a novel robot holder.

### TECHNICAL AREA

The invention relates to a robot holder for fixing a fluid-cooled joining tool rotatably about a longitudinal axis on a robot arm of a joining robot as it is cited in the generic part of claim 1.

### STATE OF THE ART

Such robot holders to which the joining tools are directly fixed for being used in conjunction with a joining technology operating with a joining medium have been known for a long time. They are used in automated joining technology, especially in automatic welding or in an automated hard soldering, and permit improved accessibility to the joining points provided in space since in addition to movements of adjusting and pivoting ensured by a moving and pivoting of the robot arm, the joining tool, e.g., a welding or hard-soldering gun, can be rotated in any case through a certain angle of rotation. Examples for comparable robot holders are disclosed in German utility models 85 19 446 and 93 05 589 of the same applicant.

A significant problem and a limitation of the previously known robot holders is in particular the fact that when the joining tools must be actively cooled with a cooling fluid, for example, cooling water, the angle of rotation for carrying out a rotary movement is basically limited. This is due to the fact that the media required for the joining procedure, thus, in particular, the cooling liquid too, are supplied directly to the joining tool via a so-called hose packet, also called a fitting, therefore, inside a flexible, hose-like apparatus running parallel to the robot holder. However, the latter becomes twisted during a rotary movement, during which such a twisting is possible only up to a certain highest extent without damage occurring to the media supply lines in the hose packet.

DE 33 00 361 A1 teaches a welding robot used in spot welding, thus, without a joining medium. This robot has a rotary feed-through for a cooling fluid. A comparable constructive solution is disclosed in DE 31 05 105 A1.

### PRESENTATION OF THE INVENTION

It is therefore desirable for an even more flexible use of automated joining tools operating with a joining medium in robots to make possible a rotation of the joining tool that is less limited in the angular range, preferably by a range of at least 360° and even more up to a rotatability that is limited, if necessary, by robot parameters but otherwise free. Accordingly, an adapted feed-through must be created for cooling fluid in such a robot holder. The present invention is concerned with this problem.

The invention provided for the solution of this task that at least one fluid line for a feed of cooling fluid designed as a bore and one cooling fluid return are present in the stator as well as in the rotor and that at least one sealed annular chamber for the cooling fluid feed and for the cooling fluid return is formed between the stator and the rotor into which chamber the associated fluid lines of the stator and of the rotor empty for a fluid feed-through.

Therefore, the essential aspect of the invention is based on the fact that the cooling fluid lines no longer run past the rotatable robot holder but rather run through it just as the feed-through for the joining medium. To this end fluid lines designed as bores are provided in accordance with the invention in the stator and in the rotor and a connection between stator and rotor is realized via an annular chamber. At least one cooling fluid line is provided in the stator and in the rotor in a separate manner for the cooling fluid feed and the cooling fluid return, and there is an annular chamber for the cooling fluid feed and cooling fluid return in which chamber the cooling fluid is transferred from the stator into the rotor and vice versa.

Thus, cooling fluid as well as the joining media that are also necessary, in particular, e.g., welding wire or soldering wire but also, if necessary, the required welding flux or soldering flux can be transferred so to say in the robot holder from the stator into the rotor with the construction in accordance with the invention. Thus, the hose packet that must always be connected in advance to the joining tool can be totally eliminated at this location so that the desired degree of freedom during the rotation of the joining tool is achieved.

Since as a rule central feed-through openings are provided for feeding through a welding or soldering wire or some other joining medium in robot holders of the initially cited type, it is advantageous if the lines for guiding cooling fluid run off-center and substantially parallel to the central feed-through in the rotor and/or the stator. Of course, the supply lines to the annular chambers must be constructed, if necessary, transversely to the actual direction of extension of the lines as tap lines, which, however, does not contradict a substantially parallel running in the sense of claim 3.

An advantageous embodiment of the invention provides that the stator extends with a pin-like connection piece running substantially in the direction of the longitudinal axis into a corresponding hollow chamber located in the rotor and is surrounded by the rotor in this area. Furthermore, the annular chambers are then formed in this area. This constructive design variant is an especially simple one in which the transfer of cooling fluid can take place with a minimum of constructive expense. This becomes especially simple if, as provided in an advantageous further development in accordance with claim 3, the annular chambers for the transfer of the cooling fluid feed and of the cooling fluid return are formed from a common chamber by separation or subdivision by means of a seal. An O-ring seal can be particularly considered for this.

Of course, in an alternative embodiment even the rotor can have a pin-like connection piece and the stator can have a hollow chamber corresponding to it as receptacle and the annular chamber feed-through can be arranged in an analogous manner in this area.

In order to be able to work with customary and known fittings for the connection to joining tools it is advantageous if the robot holder is provided on the robot side with customary connection devices for the connection of supply lines and discharge lines of the cooling fluid to the fluid lines of the stator (cf. claim 6).

In order to achieve an even further multiplicity of movements to be carried out with the joining tool provided with the robot holder in accordance with the invention, the robot holder can be additionally constructed so that it can pivot about at least one axis deviating from the longitudinal axis, as explained in claim 7.

Finally, a joining robot with the robot holder with the construction as described above is also subject matter of the invention.

### SHORT DESCRIPTION OF THE ILLUSTRATIONS OF THE DRAWINGS

The multiple advantages of the innovation are already clear from the above general description of the invention. Further advantages and features result in addition from the following description of an exemplary embodiment using the attached figures.

FIG. 1 shows a view in partial section of the robot holder in accordance with the invention on a robot arm with the joining tool connected to it as well as shows a media supply line in the form of a so-called fitting; and

FIG. 2 shows the section designated with A in FIG. 1 on an enlarged scale.

### WAY(S) FOR CARRYING OUT THE INVENTION

An exemplary embodiment is sketched schematically in the figures. The figures are not necessarily true to scale and do not clarify all details of the construction.

A robot holder 1 in accordance with the invention is flanged on one side onto a robot arm 2 indicated only schematically here, namely, with a stator 3. This stator 3 rests with a pin-like connection piece in the interior of a correspondingly constructed hollow chamber of a rotor 4 that is set on stator 3 and can rotate about it around a longitudinal axis L.

A media supply fitting 5 is connected on the robot side to the stator in which fitting a cooling fluid supply line as well as a cooling fluid discharge line, among other things, are arranged that lead, e.g., to a customary heat exchanger or to some other cooling unit. A joining tool 6 is set on rotor 4 on a front end facing away from robot arm 2, which joining tool 6 is fastened by a cap screw. Joining tool 6 is a welding gun here with a doubly bent course in order in particular to be able to approach welding points located in positions that are difficult to reach in the chamber.

A feed-through 1 for supplying a joining medium, here a welding wire, to the working tip of joining tool 6 runs centrally through the robot holder, that is, through stator 3 and robot 4.

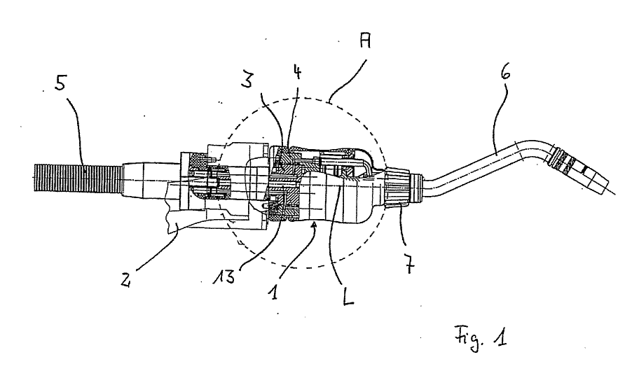

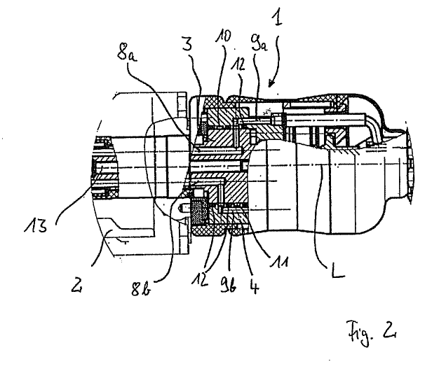

The construction and the shaping of the cooling fluid transfer in robot holder 1 can be better recognized in FIG. 2, that shows the area designated with A in FIG. 1 on an enlarged scale.

It can be clearly recognized here that two blind bores 8a and 8b running parallel to longitudinal axis L and with different lengths run in stator 3. These blind bores run with tap bores (not specifically numbered) to the outside of the pin-like connection piece, where they penetrate stator 3, during which they empty into annular chambers 10 and 11 that are sealed with O-rings 12 against the robot side as well as against the tool side and also against each other. An associated tap bore run into rotor 4 empties into each of these corresponding annular chambers 10, 11, which tap bores finally empty into associated blind bores 9a and 9b. This system of bores creates, together with the particular associated annular chamber 10 and 11, a cooling fluid line that is transferred from stator 3 into rotor 4 at the position of the associated annular chamber 10 or 11 and runs further into joining tool 6 via a connection not shown in detail here. One of the lines 8a, 9a or 8b, 9b with the particular associated feed-through through annular chamber 11 or 10 is a line for the cooling fluid feed and the other line fowls the cooling fluid return.

The selection shown here of an annular chamber 11, 10 constructed by outward O-ring seals 12 as well as against the adjacent annular chamber 10, 11 for the transfer of cooling fluid ensures that a feed-through of cooling fluid that is independent of the position of rotation is given that ensures in particular no limitations regarding the freest possible rotatability of joining tool 6 relative to robot arm 2, that is, of robot 4 relative to stator 3. Therefore, the construction in accordance with the invention achieves the goal of an improvement of the flexibility in the rotation of joining tool 6 relative to robot arm 2 in a simple but convincing manner.

### LIST OF REFERENCE NUMERALS

1 robot holder

2 robot arm

3 stator

4 robot

5 media supply fitting

6 joining tool

7 cap screw

8a,b bore

9a,b bore

10 annular chamber

11 annular chamber

12 O-ring

13 central feed-through

L longitudinal axis

1. A robot holder for fixing a fluid-cooled joining tool rotatably about a longitudinal axis on a robot arm of a joining robot with a stator that can be fastened on the robot arm and with a rotor that comprises a connection for the joining tool and that can rotate about the stator, in which a feed-through for a joining medium, in particular for a welding wire or soldering wire, runs inside the robot holder through the stator and the rotor, wherein at least one fluid line designed as a bore for a cooling fluid feed and the cooling fluid return is present in the stator as well as in the rotor, and that at least one sealed annular chamber for the cooling fluid feed and the cooling fluid return is constructed between the stator and the rotor into which the particular associated fluid lines of the stator and of the rotor empty for a fluid feed-through.

2. The robot holder according to claim 1, wherein the feed-through opening is a central feed-through opening.

3. The robot holder according to claim 2, wherein the lines for the cooling fluid run off-center and substantially parallel to the central feed-through opening.

4. The robot holder according to claim 1, wherein the stator extends with a pin-like connection piece running substantially in the direction of the longitudinal axis into a corresponding hollow chamber located in the rotor and is surrounded by the rotor in this area, and that the annular chambers are formed in this area.

5. The robot holder according to claim 4, wherein the annular chambers are formed from a common chamber by separation by means of a seal, in particular an O-ring seal.

6. The robot holder according to claim 1, further comprising customary connection devices on the robot side for the connection to supply lines and discharge lines for the cooling fluid to the fluid lines of the stator.

7. The robot holder according to claim 1, wherein the holder is additionally constructed so that it can pivot about at least one axis deviating from the longitudinal axis.

8. The robot holder according to claim 1, wherein the rotor includes connections for receiving a welding gun or a soldering gun.

9. A joining robot, characterized by a robot holder according to claim 1.
